(19) United States
(12) Patent Application Publication
(10) Pub. No.: US 2011/0006562 A1
(43) Pub. Date: Jan. 13, 2011

(54) MODULAR FLOOR SYSTEM FOR VEHICLES

(75) Inventors: Douglas Carl Campbell, Salem, NY (US); David George Mann, Charlotte, NC (US)

Correspondence Address: K&L Gates LLP, 214 N. TRYON STREET, HEARST TOWER, 47TH FLOOR, CHARLOTTE, NC, 28202, US

(73) Assignee: Specialty Manufacturing, Inc., Pineville, NC (US)

(21) Appl. No.: 12/830,793

(22) Filed: Jul. 6, 2010

Related U.S. Application Data
(60) Provisional application No. 61/270,428, filed on Jul. 8, 2009.

(51) Int. Cl. B62D 25/20; B21D 53/88

(52) U.S. Cl. 296/193.04; 29/897.2

(57) ABSTRACT

A modular floor system comprising at least one floor panel for use in a vehicle. The floor panel is comprised of a top surface material and an interlocking subfloor having one or more interlocking pieces. The top surface material and the interlocking subfloor are affixed to one another. Another aspect of the invention is a method of making a modular floor panel. The method comprises obtaining a top surface material, obtaining an interlocking subfloor having one or more interlocking pieces, and affixing the top surface material and the interlocking subfloor to one another. The top surface material and the interlocking subfloor are preferably affixed to one another by bonding.

### CROSS-REFERENCE TO RELATED APPLICATIONS

This application claims priority from U.S. Provisional Patent Application No. 61/270,428, filed on Jul. 8, 2009. The disclosure of which is incorporated herein by reference.

### FIELD OF THE INVENTION

The present invention relates to a floor system for a vehicle, more particularly to a modular floor system for a vehicle.

### BACKGROUND OF THE INVENTION

Most floor assemblies in conventional vehicle assembly operations, particularly in heavy equipment and bus or van applications, include a vehicle structural subfloor of steel or aluminum, a plywood or fiber-composite subfloor, and a top surface material which is usually constructed from vinyl or rubber. The entire subfloor is typically created by cutting standard size plywood or fiber-composite sheet stock material (e.g., 4′×8′ sheets) into multiple, discreet sections based on the profile of the vehicle floor and in order to accommodate various components that must be routed or accessed through the floor. Depending upon the size of the vehicle, this could result in a dozen or more individual pieces that must be placed onto the steel or aluminum vehicle subfloor in a “puzzle-like” manner. After placing the individual subfloor pieces, they are attached to the metallic vehicle subfloor with fasteners which are typically spaced apart by less than one foot in a pattern across the floor of the vehicle. Even closer spacing is used in the areas of the subfloor seams. To apply the top surface material, the floor must be cleaned and prepped for application of the adhesive which bonds the two materials together. The adhesive must be applied in a controlled and even manner and allowed to cure before subsequent processing may take place. All of these steps are typically performed on the main vehicle assembly line.

The process and materials mentioned above contain several potential negative aspects. First, it requires a very labor-intensive operation. This operation involves the steps of placing the multiple subfloor sections into the vehicle, installing dozens of fasteners through the subfloor, and preparing the surface of the subfloor for attaching the top surface. Additionally, this process has further drawbacks, which include an adhesive cure time for the top surface that may be excessive relative to other operations and an increased potential for worker injuries with additional labor around the vehicle (this is particularly true while the line is moving). Additional precautions are necessary for the adhesive fumes (e.g., special ventilation). There is an increased potential for slip hazards and paint contamination from the resulting saw dust, and the use of plywood or fiber-composite flooring materials results in increased likelihood of damage and degradation due to moisture penetration, which in turn leads to an increased likelihood of the flooring material budding.

### SUMMARY OF THE INVENTION

The present invention relates to a modular floor panel system for use in a vehicle. The modular floor system comprises at least one floor panel. The floor panel is comprised of a top surface material and an interlocking subfloor having one or more interlocking pieces. The top surface material and the interlocking subfloor are affixed to one another.

Another aspect of the invention is a method of making a modular floor panel. The method comprises obtaining a top surface material, obtaining an interlocking subfloor having one or more interlocking pieces, and affixing the top surface material and the interlocking subfloor to one another. The top surface material and the interlocking subfloor are preferably affixed to one another by bonding.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is an exploded view of a modular floor system in accordance with the present invention in a multi-piece floor panel construction.

FIG. 2 is a perspective view of the top side of a subfloor panel of a floor panel in accordance with the modular floor system of the present invention.

FIG. 3 is a perspective view of the underside of a subfloor panel having a structural grid pattern.

FIG. 4 is a view illustrating an interlocking feature of the subfloor of the present invention.

FIG. 5 is a sectional side view illustrating an adhesive bonded floor panel construction in accordance with the present invention.

FIG. 6 is a sectional side view illustrating a thermally bonded floor panel construction in accordance with the present invention.

FIG. 7 is a partial view of a subfloor that has been formed into a structural grid pattern prior to contact with the top surface material.

FIG. 8 is a partial view illustrating the interlocking mechanism feature of the subfloor in accordance with the present invention prior to the subfloor pieces being interlocked together.

FIG. 9 is a partial view illustrating the interlocking mechanism feature of the subfloor in accordance with the present invention after the subfloor pieces are interlocked together.

FIG. 10 is an exploded view of a modular floor system in accordance with the present invention in which the top surface material is comprised of a single piece.

FIG. 11 is a perspective view of an installed modular floor system of the present invention in which the modular floor system also includes a wheelchair track system.

### DETAILED DESCRIPTION OF THE INVENTION

The following detailed description of the embodiment(s) is merely exemplary in nature and is in no way intended to limit the invention, its application, or uses.

The present invention is directed to a modular floor system for a vehicle. The modular floor system comprises at least one floor panel. A floor panel is pre-cut or pre-formed to match a particular vehicle floor layout. A single floor panel may be used. Alternatively, multiple floor panels may be used.

The floor panel comprises a top surface material and an interlocking subfloor affixed to the top surface material. The top surface material and the interlocking subfloor may each be formed as a subassembly. The subfloor and top surface subassemblies are prepared before vehicle assembly in a manner that provides the greatest surface area coverage in a size that allows appropriate manipulation during the vehicle assembly operation. The floor panels are also cut or formed to match the floor shape of the vehicle and to accommodate various components that must be routed or accessed through the floor. The subfloor is preferably comprised of a polymeric or elastomeric material that is molded, formed, or manufactured into a structural grid that contains additional features for securing it to the vehicle floor assembly. The top surface material and subfloor are preferably permanently attached or affixed to one another.

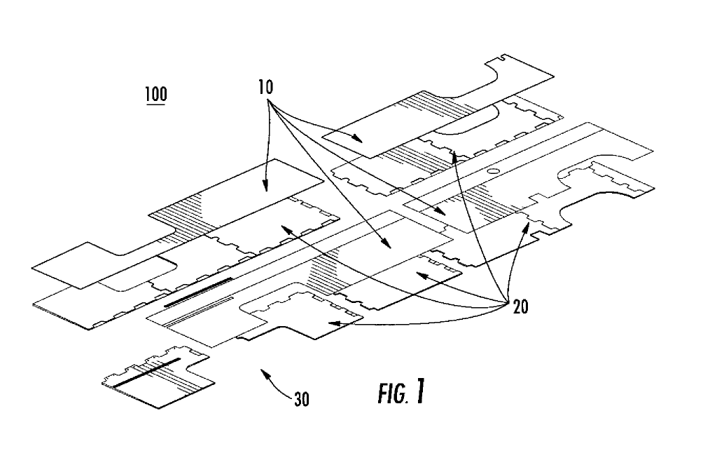

Referring now to the figures, FIG. 1 is an exploded view of a modular floor system 100 in accordance with the present invention in a multi-piece floor construction. FIG. 1 illustrates a top surface material 10 and a subfloor 20. Also, as shown in FIG. 1, the subfloor 20 optionally comprises a cut out 30. The subfloor 20 has an interlocking mechanism.

The top surface material 10 is shaped through thermal cutting, water jet cutting, Computer Numeric Controlled (CNC) cutting, or other known shaping or cutting methods. The top surface material 10 is comprised of any floor covering material or a combination of one or more floor covering materials. The choice of a top surface material may depend upon what is typical for a particular industry or use. Examples of materials suitable for use as a top surface material in accordance with the present invention include, but are not limited to, polymeric materials and elastomeric materials. Examples of suitable polymeric materials include, but are not limited to, polyethylene such as High Density Polyethylene (HDPE) and Low Density Polyethylene (LDPE), polypropylene, urethane, vinyl, other thermoplastic resin materials or a combination thereof. Examples of suitable elastomeric materials include, but are not limited to, rubber. The materials may be adjusted by known methods to address specific needs, such as color, hardness, abrasion resistance, or other parameters.

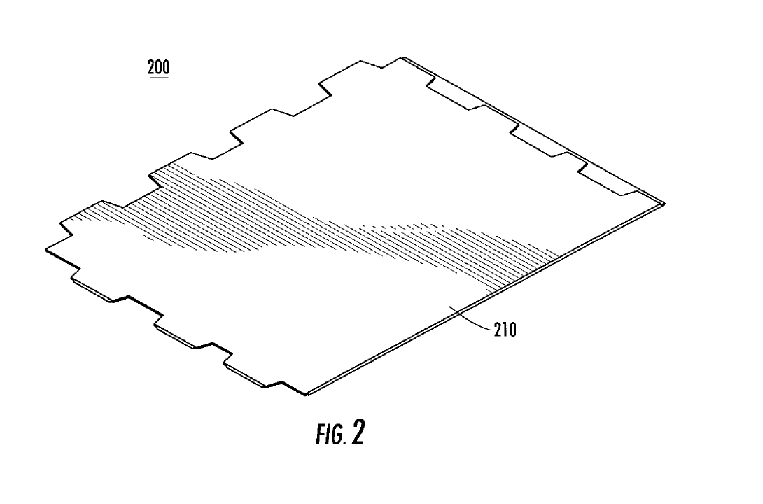

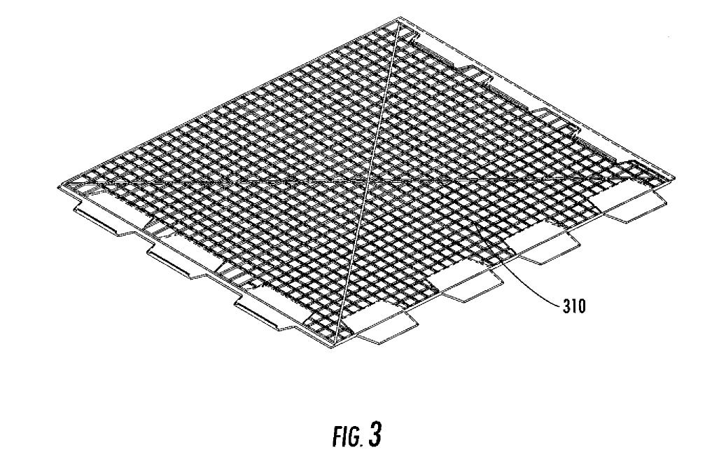

FIG. 2 is a perspective view of the top side or surface 210 of a subfloor panel 200. FIG. 3 is a perspective view of the underside or surface 310 of the subfloor panel 200 of FIG. 2.

The subfloor 20, shown in FIG. 1, is shaped through thermal cutting, water jet cutting, Computer Numeric Controlled (CNC) cutting, or other known shaping or cutting methods. The choice of a material for a subfloor may depend upon what is typical for a particular industry or use. Examples of materials suitable for use as a subfloor in accordance with the present invention include, but are not limited to, polymeric materials and elastomeric materials. Examples of suitable polymeric materials include, but are not limited to, polyethylene such as High Density Polyethylene (HDPE) and Low Density Polyethylene (LDPE), polypropylene, urethane, vinyl, other thermoplastic resin materials or a combination thereof. Examples of suitable elastomeric materials include, but are not limited to, rubber. The materials may be adjusted by known methods to address specific needs, such as color, hardness, abrasion resistance, or other parameters. The material of the subfloor 20 preferably is a moisture resistant material, an anti-fungal material, an anti-microbial material, or a combination thereof. Additionally, the top surface material 10 may be comprised of the same material as the material of the subfloor 20.

FIG. 3 is a perspective view of the underside 310 of the subfloor panel 200 of FIG. 2 having a structural grid pattern. The subfloor panel 200 is optionally formed or manufactured entirely or partly into a structural grid pattern, as illustrated in FIG. 3. The grid pattern provides additional strength for mounting of various components, as it aids in the resistance of the compressive forces of the components mounted to the floor.

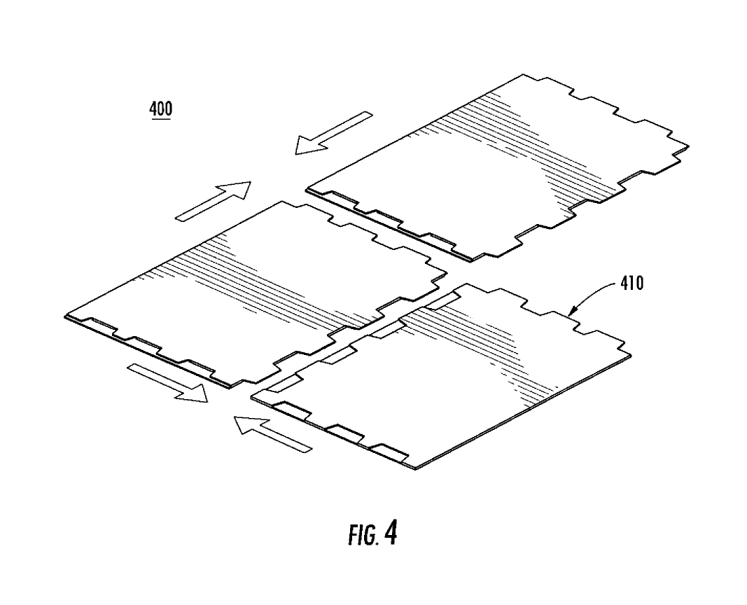

FIG. 4 is a view illustrating an interlocking feature of subfloor 20 of the present invention. FIG. 4 illustrates an interlocking mechanism of the subfloor 20 in the modular floor system of the present invention by which the subfloor 20 provides interlocking between adjoining panels. An example of a suitable interlocking mechanism is an interlocking tab 410. The interlocking feature of the present invention is utilized, for example, either before or during the vehicle assembly process.

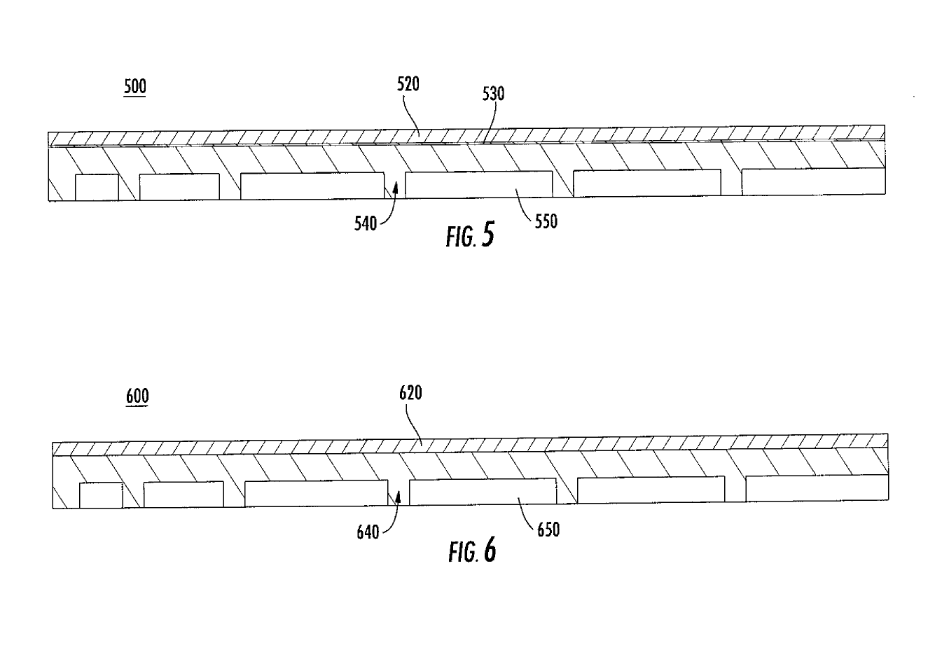

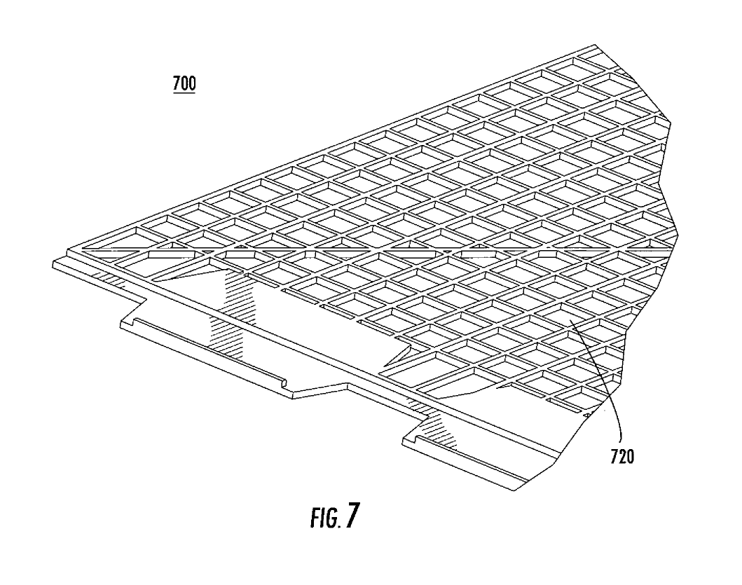

The top surface material 10 and the subfloor 20 may be attached or affixed to each other in a variety of ways. One acceptable method, as illustrated in FIG. 5, is attachment of the top surface material 520 and the subfloor 540 by using an adhesive bonding application. Any adhesive that is typical in the industry may be used. FIG. 5 is a sectional side view illustrating an adhesive bonded floor panel construction in accordance with the present invention. FIG. 5 illustrates an adhesive bonding material 530 having been applied between top surface material 520 and subfloor 540 to attach or affix subfloor 540 to top surface material 520. FIG. 6 is a sectional side view illustrating a thermally bonded floor panel construction in accordance with the present invention. FIG. 6 also shows top surface material 620 and subfloor 640 affixed to one another. The top surface material optionally possesses a modified surface texture (not shown). As seen in FIGS. 5 and 6, the subfloor is optionally formed or manufactured with voids or “hollow features”, 550 and 650, respectively, as seen from the sectional views. FIGS. 5 and 6 thus further illustrate the cross-section of the panels shown in FIGS. 1 and 3.

An additional method of joining or affixing the subfloor 20 and the top surface material 10 is to mold or manufacture the subfloor 20 and the top surface material 10 at the same time. Therefore, it is acceptable to have the top surface material molded or manufactured into place at the time of the manufacture of the subfloor. Similarly, the top surface material may also be applied to the subfloor in a fluid form and then be cured prior to further processing. Once joined or attached, the top surface material and the subfloor form a floor panel that can be cut and shaped using the techniques described above and installed in vehicles.

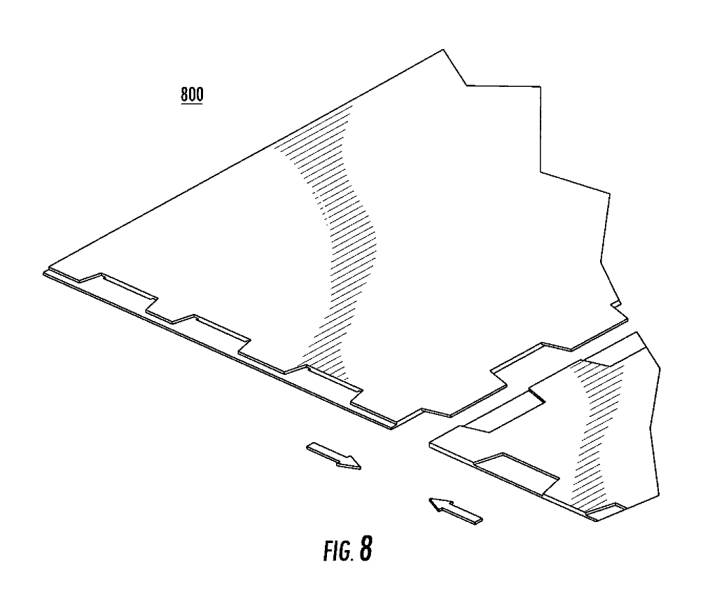

FIG. 7 is a partial view of a subfloor that has been formed into a structural grid pattern 720 prior to contact with the top surface material.

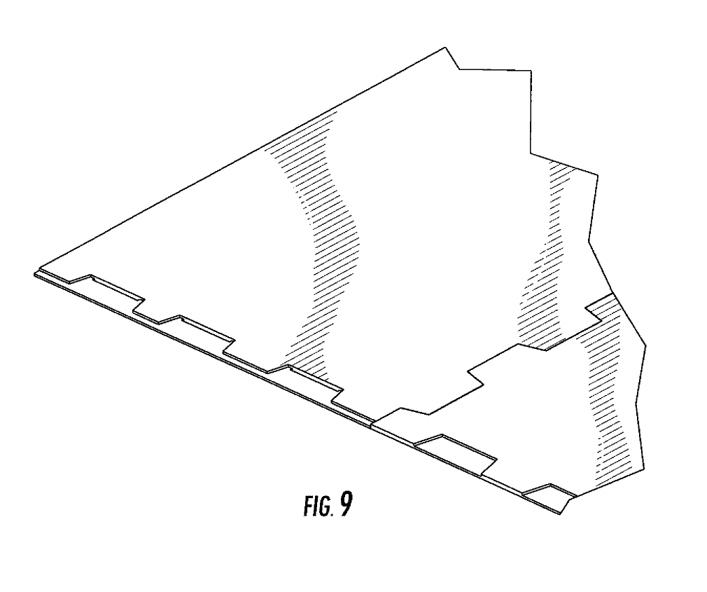

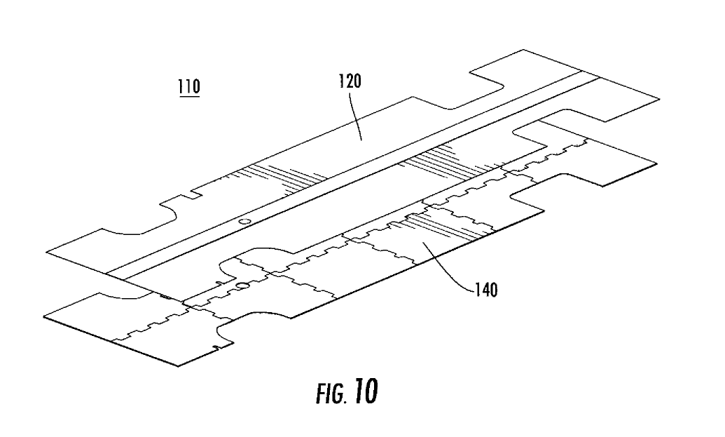

FIG. 8 is a partial view illustrating the interlocking mechanism feature of the subfloor 800 in accordance with the present invention prior to pieces of the subfloor 800 being interlocked together. FIG. 9 is a partial view illustrating the interlocking mechanism feature of the subfloor 800 in accordance with the present invention after pieces of the subfloor 800 are interlocked together.

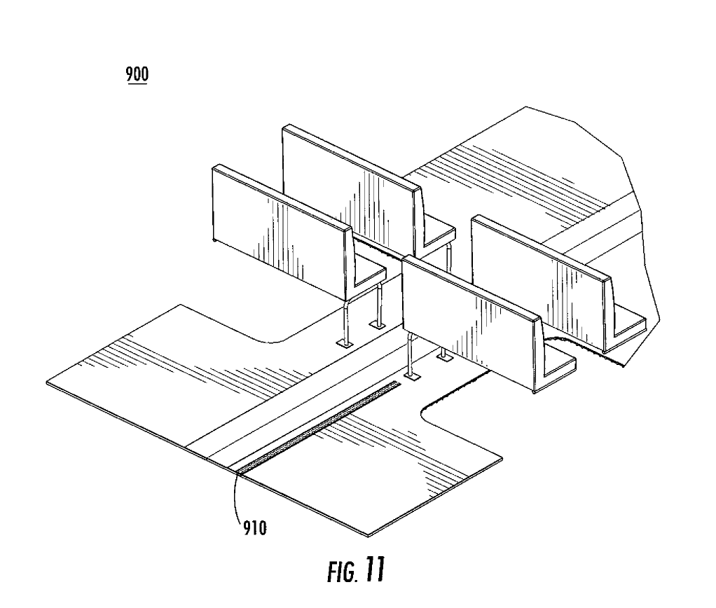

FIG. 10 is an exploded view of a modular floor system 110 in accordance with the present invention in which the top surface material is comprised of a single piece. When combined, the top surface material 120 and the subfloor 140 may form a single piece as seen in FIG. 10 and may be suitable for use as the flooring for an entire vehicle or may serve as an individual modular floor panel which is then used as a component of a multi-piece floor panel construction as seen in FIG. 1.

FIG. 11 is a perspective view of an installed modular floor system 900 of the present invention in which the modular floor system also includes a wheelchair track system. As illustrated in FIG. 11, the top surface material may accommodate various seat or wheelchair track systems through the use of an insert 910 formed to interlock with the top surface material and mate with the track system.

When installing the flooring materials to form a vehicle floor, the assembly line workers place the modular floor panels into the vehicle as required for the specific manufacturing operation. As the modular floor system uses the interlock feature shown in FIGS. 8 and 9, the floor panels do not require as many fasteners to secure to the vehicle subfloor as the flooring materials of other known methods. Additionally, since the panels already include the top surface material, there is no need for the installer to clean the subfloor, apply the adhesive, and allow for a cure time. This results in increased efficiency for the installer, as well as improved safety conditions.

There are fewer assembly and installation steps with the modular floor system of the present invention, which in turn leads to an increase in both safety and efficiency. Further, the pre-assembly of the panels in the manner of the present invention also requires the use of less adhesive at installation. This results in a significant reduction in both the adhesive fumes and the resulting safety issues attendant with the use of adhesives. Additionally, the use of non-plywood flooring materials all but eliminates the likelihood of the floor undergoing buckling following the installation of the floor panels.

An additional advantage of the present invention is a lesser number of panels are required for larger vehicles than in conventional methods. Unlike conventional methods, the present invention requires less floor panels as a result of using the sheet stock material described herein. Further, the ability to use fewer and larger sheets, up to and including a single sheet of flooring material, provides increased efficiency and safety.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A modular floor system comprising at least one floor panel for use in a vehicle, the floor panel comprised of a top surface material and an interlocking subfloor having one or more interlocking pieces, wherein the top surface material and the interlocking subfloor are affixed to one another.

2. The modular floor system as claimed in claim 1, wherein the top surface material is comprised of a polymeric material or an elastomeric material.

3. The modular floor system as claimed in claim 2, wherein the polymeric material is polyethylene, polypropylene, urethane, vinyl, other thermoplastic resin material or a combination thereof.

4. The modular floor system as claimed in claim 2, wherein the elastomeric material is rubber.

5. The modular floor system as claimed in claim 1, wherein the subfloor is comprised of a polymeric material or an elastomeric material.

6. The modular floor system as claimed in claim 5, wherein the polymeric material is polyethylene, polypropylene, urethane, vinyl, other thermoplastic resin material or a combination thereof.

7. The modular floor system as claimed in claim 5, wherein the elastomeric material is rubber.

8. The modular floor system as claimed in claim 1, wherein the subfloor has a structural grid pattern.

9. The modular floor system as claimed in claim 1, wherein the subfloor provides interlocking between floor panels.

10. The modular floor system as claimed in claim 1, wherein the top surface material and the subfloor are affixed to one another by bonding.

11. The modular floor system as claimed in claim 10, wherein the top surface material and the subfloor are bonded to one another with an adhesive.

12. The modular floor system as claimed in claim 10, wherein the top surface material and the subfloor are thermally bonded to one another.

13. The modular floor system as claimed in claim 1, wherein the top surface material is molded to the subfloor.

14. The modular floor system as claimed in claim 1, wherein the top surface and the subfloor are comprised of the same material.

15. The modular floor system as claimed in claim 1, wherein the top surface material has a modified surface texture.

16. The modular floor system as claimed in claim 1, wherein the subfloor is formed into a structural grid.

17. The modular floor system as claimed in claim 1, wherein the subfloor comprises a void or a hollow feature.

18. The modular floor system as claimed in claim 1, wherein the subfloor comprises an interlocking mechanism.

19. The modular floor system as claimed in claim 18, wherein the interlocking mechanism is an interlocking tab.

20. The modular floor system as claimed in claim 1, wherein the top surface material is comprised of a single piece without seams.

21. The modular floor system as claimed in claim 20, wherein the single piece is either for an entire vehicle or for use as an individual modular floor panel.

22. The modular floor system as claimed in claim 1, wherein the top surface material is in multiple pieces.

23. The modular floor system as claimed in claim 1, wherein the multiple pieces are either for an entire vehicle or for use as an individual modular floor panel.

24. The modular floor panel system as claimed in claim 1, wherein the top surface material is shaped by thermal cutting, water jet cutting, or Computer Numeric Controlled (CNC) cutting.

25. The modular floor system as claimed in claim 1, wherein a seat track or a wheelchair track is installed through the use of an insert formed to interlock with the subfloor and to mate with the seat track or the wheelchair track.

26. A modular floor panel for use in a vehicle, the floor panel comprising:
a top surface material, and
an interlocking subfloor having one or more interlocking pieces,
wherein the top surface material and the interlocking subfloor are affixed to one another.

27. A method of making a modular floor panel comprising:
obtaining a top surface material,
obtaining an interlocking subfloor having one or more interlocking pieces, and
affixing the top surface material and the interlocking subfloor to one another.

28. The method of making a modular floor panel as claimed in claim 27, wherein the top surface material and the interlocking subfloor are affixed by bonding.

29. The method of making a modular floor panel as claimed in claim 27, wherein the top surface material and the interlocking subfloor are affixed by applying the top surface material in a form of a fluid to the interlocking subfloor.

29. The method of making a modular floor panel as claimed in claim 29, further comprising curing the fluid.
